(19) United States
(12) Patent Application Publication
(10) Pub. No.: US 2026/0142956 A1
(43) Pub. Date: May 21, 2026

(54) IMPLICIT SECURITY VIA SECURED SCRAMBLING

(71) Applicant: QUALCOMM Incorporated, San Diego, CA (US)

(72) Inventors: Richard Dominic WIETFELDT, San Diego, CA (US); Jonathan PETIT, Wenham, MA (US)

(21) Appl. No.: 18/952,839

(22) Filed: Nov. 19, 2024

(51) Int. Cl. H04L 9/40

(52) U.S. Cl. CPC H04L 63/061

(57) ABSTRACT

Systems and techniques are provided for securing data. For instance, a process can include: obtaining a session key based on a security handshake operation with a sensor controller; obtaining sensor data from a sensor; scrambling the sensor data based on the session key to generate scrambled sensor data; and outputting the scrambled sensor data to the sensor controller for processing.

### FIELD

The present application is related to capturing images. For example, aspects of the present application relate to systems and techniques for implicit security via secured scrambling.

### BACKGROUND

Various types of sensors can be used to capture sensor data representative of a scene. For example, a camera is a device that receives light and captures image frames, such as still images or video frames, using an image sensor. Other types of sensors include radio detection and ranging (radar) sensors and light detection and ranging (LIDAR) sensors that capture electromagnetic radiation in different forms. Cameras may include one or more processors, such as image signal processors (ISPs), that can process one or more image frames captured by an image sensor. For example, a raw image frame captured by an image sensor can be processed by an image signal processor (ISP) to generate a final image. Radar and/or LIDAR sensors may also include one or more processors that can process the radar/LIDAR data. However, as sensor data is transmitted between the image sensor and downstream processors, such as the ISP and/or other processor(s), electromagnetic (EM) emissions may be generated. In some cases, an attacker may be able to detect these EM emissions and reconstruct the captured sensor data (e.g., camera images, radar data, LIDAR data, etc.). In some cases, techniques for mitigating such eavesdropping exploits may be useful.

### SUMMARY

Systems and techniques are described herein for image processing. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, apparatuses, methods and computer-readable media for image processing are provided. In one illustrative example, an apparatus for securing data is provided. The apparatus includes at least one memory; and at least one processor coupled to the at least one memory. The at least one processor is configured to: obtain a session key based on a security handshake operation with a sensor controller; obtain sensor data from a sensor; scramble the sensor data based on the session key to generate scrambled sensor data; and output the scrambled sensor data to the sensor controller for processing.

As another example, a method for securing data is provided. The method includes: obtaining a session key based on a security handshake operation with a sensor controller; obtaining sensor data from a sensor; scrambling the sensor data based on the session key to generate scrambled sensor data; and outputting the scrambled sensor data to the sensor controller for processing.

In another example, a non-transitory computer-readable medium having stored thereon instructions is provided. The instructions, when executed by at least one processor, cause the at least one processor to: obtain a session key based on a security handshake operation with a sensor controller; obtain sensor data from a sensor; scramble the sensor data based on the session key to generate scrambled sensor data; and output the scrambled sensor data to the sensor controller for processing.

As another example, an apparatus for securing data is provided. The apparatus includes: means for obtaining a session key based on a security handshake operation with a sensor controller; means for obtaining sensor data from a sensor; means for scrambling the sensor data based on the session key to generate scrambled sensor data; and means for outputting the scrambled sensor data to the sensor controller for processing.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) can include at least one camera for capturing one or more images or video frames. For example, the apparatus(es) can include a camera (e.g., an RGB camera) or multiple cameras for capturing one or more images and/or one or more videos including video frames. In some aspects, the apparatus(es) can include at least one display for displaying one or more images, videos, notifications, or other displayable data. In some aspects, the apparatus(es) can include at least one transmitter configured to transmit one or more video frame and/or syntax data over a transmission medium to at least one device. In some aspects, the at least one processor can include a neural processing unit (NPU), a neural signal processor (NSP), a central processing unit (CPU), a graphics processing unit (GPU), a digital signal process (DSP), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure;

FIG. 2 is a block diagram illustrating an imaging system, in accordance with aspects of the present disclosure;

FIG. 3 is a block diagram illustrating an encrypted imaging system, in accordance with aspects of the present disclosure;

FIG. 4 is a block diagram illustrating secure scrambling for an imaging system, in accordance with aspects of the present disclosure;

FIG. 5 is a block diagram illustrating secure scrambling for sensor data, in accordance with aspects of the present disclosure;

FIG. 6A illustrates an example secure scrambling engine, in accordance with aspects of the present disclosure;

FIG. 6B is a block diagram illustrating a set of parallel secure scrambling engines 650, in accordance with aspects of the present disclosure;

FIG. 7 is a block diagram illustrating secure scrambling for an imaging system, in accordance with aspects of the present disclosure;

FIG. 8 is a flow diagram illustrating a process for securing data, in accordance with aspects of the present disclosure; and

FIG. 9 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

Cameras and other sensors (e.g., radio detection and ranging (radar) sensors, light detection and ranging (LIDAR) sensors, and/or other types of sensors) may be integrated into a variety of devices to allow these devices to perform a large number of tasks. In some cases, sensor data produced by the cameras and other sensors may be captured and transmitted to a sensor controller, such as an ISP or another sensor controller integrated into an SOC. Processing and transmitting the sensor data can result in electromagnetic (EM) emissions. For example, a sensor (e.g., a camera or image sensor, a radar sensor, a LIDAR sensor, etc.) may be etched onto a die and this die may be coupled via a die-to-die interface to another die that includes sensor logic which may packetize and transmit the sensor data (e.g., image data, radar data, LIDAR data, etc.), for example, to the ISP via an interface. In some cases, the interface and even the die-to-die interface may produce EM emissions as the sensor data is transmitted over them. Additionally, circuits of the sensor logic and ISP may generate EM emissions. In some cases, these EM emissions may be received by an eavesdropper and may be used to recreate the sensor data captured by the sensor (e.g., images captured by the image sensor).

In some cases, encryption may be applied to the sensor data to protect the sensor data as the sensor data is processed and transmitted from the sensor to the sensor controller. However, implementing digital logic for an encoder for encryption onto a sensor die may be difficult, and absent such an implementation, there may still be EM emissions as between the sensor and the sensor logic. Additionally, unencrypted transmission EM emissions may still occur even where the sensor logic is integrated with the sensor. In some cases, techniques to reduce these unencrypted EM emissions may be useful.

Systems, apparatuses, electronic devices, methods (also referred to as processes), and computer-readable media (collectively referred to herein as “systems and techniques”) are described herein for implicit security via secured scrambling. In some cases, a modified form of data scrambling using a dynamic operator for scrambling may be used to further reduce unencrypted EM emissions. In some cases, scrambling may be implemented using relatively simple digital logic as compared to cryptographic techniques and therefore scrambling may be performed closer to the digital sampling of the analog medium (e.g., amount of light captured by photoreceptors of an image sensor or camera). For example, scrambling may be performed on the sensor data generated by sampling the analog medium before the sensor data is stored in a memory and/or processed by another circuit.

As indicated above, scrambling may be performed based on a dynamic operator. In some cases, this dynamic operator may be a symmetric temporary session key. In some cases, as a part of the registration procedure as a part of manufacturing, a sensor system (e.g., sensor logic and sensor) and a sensor controller (e.g., ISP, SoC, etc.) may exchange a secret root key that may be used to derive other cryptographic keys, such as the session key using a key derivation function. In some cases, a security handshake operation (e.g., distributed management task force (DMTF), security protocols and data model (SPDM), internet engineering task force (IETF), transport layer security (TLS) handshake, and/or another set of operations to establish a connection) between the sensor system (e.g. sensor logic board/die) and the sensor controller may be, for example, performed periodically, such as on boot of a device and/or the sensor system and during this security handshake operation, a new temporary session key may be derived.

The scrambling of the sensor data may be performed based on the session key. In some cases, a set of sync bits as stored in a sync register may be generated based on the session key, such as by using a predetermined portion of the session key as the sync bits, or by deriving the sync bits from the session key. The sync bits can include a set of bits that may be used to scramble sensor data. In some cases, the sensor logic may perform the handshake operation, generate the sync bits, and store the sync bits in a register of the sensor. The sensor may scramble the sensor data based on the sync bits stored in the register. In some cases, the scrambling may be performed using an exclusive or (XOR) operation. For example, the sensor data may be XOR'd with the sync bits to generate scrambled sensor data. In some cases, the scrambled sensor data may be unscrambled, for example, by the controller, by performing the XOR operation again with the sync bits (generated by the controller based on the session key) to obtain the original unscrambled sensor data.

Various aspects of the application will be described with respect to the figures.

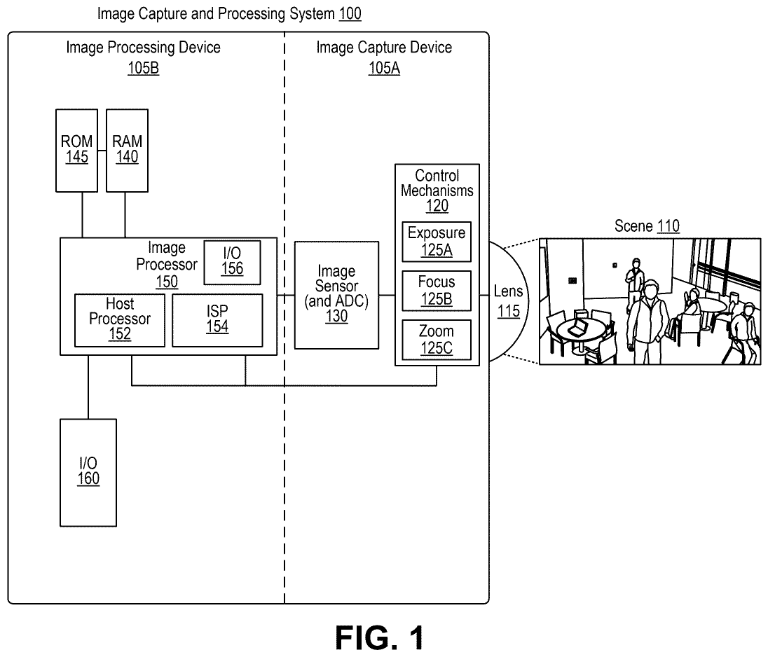

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

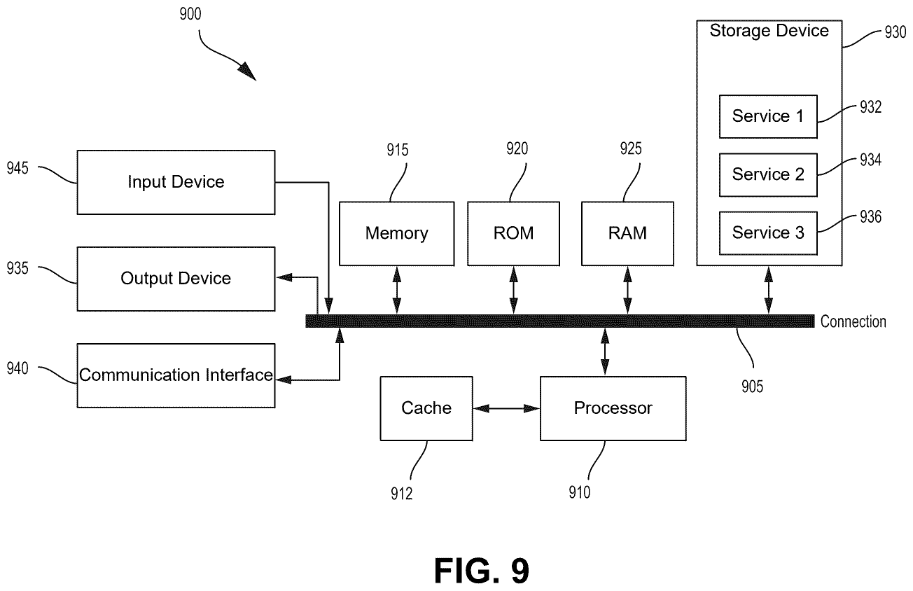

The image processor 150 may include one or more processors, such as one or more image signal processors (ISPs) (including ISP 154), one or more host processors (including host processor 152), and/or one or more of any other type of processor 910 discussed with respect to the computing system 900 of FIG. 9. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., BluetoothTM, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as demosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, camera systems in devices may generate EM emissions as image data is created by and/or transmitted from an image sensor. These EM emissions may be remotely sniffed and/or eavesdropped by an attacker and used to recreate images captured by the image sensor.

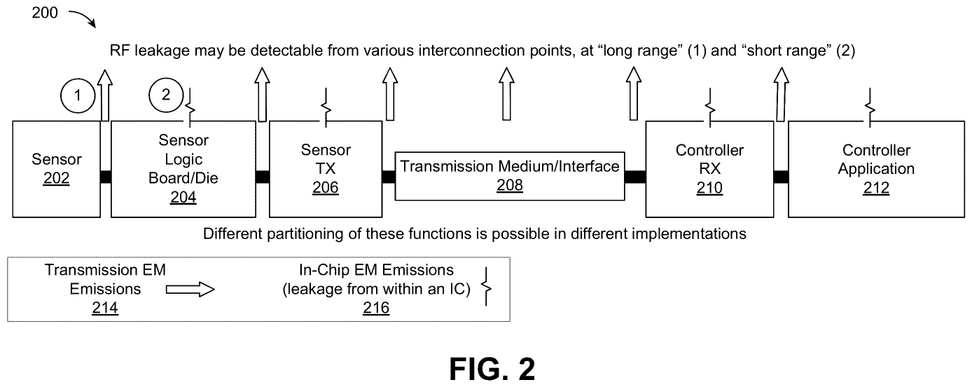

FIG. 2 is a block diagram illustrating an imaging system 200, in accordance with aspects of the present disclosure. In FIG. 2, a sensor 202, such as an image sensor, may capture (e.g., sense) information about an environment. In some cases, the sensor 202 may be mounted to a sensor logic board 204 (e.g., sensor die) and the sensor 202 may send captured sensor data (e.g., via an electrical connection, such as wires/cables, to circuits of the sensor logic board 204. In some cases, the sensor logic board 204 may be a set of circuits/electronic logic that his mounted on a same die (e.g., chip) as the sensor 202. In some cases, the sensor logic board 204 may packetize or otherwise package/prepare the raw sensor data into a data transmission format (e.g., mobile industry processor interface (MIPI) format, camera serial interface (CSI) format, etc.) for transmission. The sensor logic board 204 may send the packetized sensor data to a sensor transmitter 206. In some cases, the sensor transmitter 206 may be a part of the sensor logic board 204 and mounted on a same die as the sensor 202. The sensor transmitter 206 may transmit the packetized sensor data via a transmission medium 208 (e.g., interface) to a controller receiver 210. The transmission medium 208 may be one or more wireless transmissions, wires, cables, etc. electronically or electromagnetically coupling the sensor transmitter 206 and the controller receiver 210. In some cases, the transmission medium 208 may include one or more memories. In some cases, the controller receiver 210 may be a part of a processor separate from the sensor 202 and sensor logic board 204, such as an ISP, DSP, NSP, general purpose processor (e.g., CPU), or other processor for processing the sensor data. The controller receiver 210 may receive the packetized sensor data from the sensor transmitter 206 and send the sensor data to a controller application 212 for processing.

In some cases, EM emissions from transmissions (e.g., transmission EM emissions 214) may be generated each time the sensor data is transmitted between circuits. For example, transmission EM emissions 214 may be generated when the sensor transmits the image data to the sensor logic board 204, when the packetized sensor data is transmitted to the sensor transmitter 206, when the packetized sensor data is transmitted over the transmission medium, and so forth. Additionally, the circuits themselves (e.g., sensor logic board 304, sensor transmitter 306, controller receiver 310, and controller application 312) may leak radio frequency (RF) signals as in-chip EM emissions 216 as the circuits process data from the sensors. In some cases, the transmission EM emissions 214 may be detected further from the imaging system 200, as compared to the in-chip EM emissions 216.

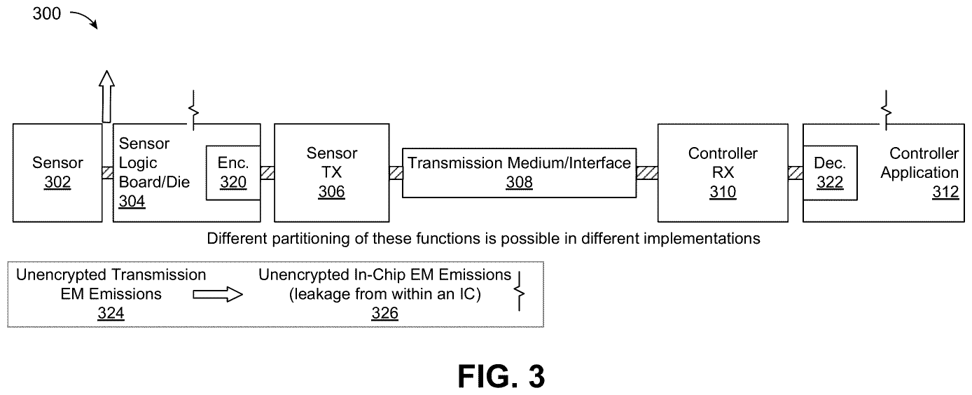

In some cases, encryption may be applied to help secure the transmission of the sensor data. FIG. 3 is a block diagram illustrating an encrypted imaging system 300, in accordance with aspects of the present disclosure. Similar to imaging system 200, the encrypted imaging system 300 includes a sensor 302, sensor logic board 304, a sensor transmitter 306, transmission medium 308, controller receiver 310, and controller application 312. In FIG. 3, the sensor logic board includes an encoder 320, which may encrypt the sensor data received by the sensor logic board 304 from the sensor 302. This encrypted sensor data may be passed from the sensor logic board 304 to the sensor transmitter 306, where the encrypted sensor data may be transmitted over the transmission medium 308 to the controller receiver 310 and to a decoder 322 of the controller application 312.

The sensor 302, as with sensor 202, may sense the environment in an analog manner (e.g., receiving some amount of light) and then make a digital measurement of the environment (e.g., measuring the amount of light gathered). In some cases, the encoder 320 may be implemented as close to where this digital measurement is performed as possible. In this example, the encoder 320 is located on the sensor logic board 304 as the encoder 320 may use a certain amount of digital logic for implementation, and it can be difficult to include the encoder 320 with the sensor 302. In other cases, the encoder 320 may be integrated on the sensor 302. In yet other cases, the encoder may be implemented in the sensor transmitter 306. Similarly, the decoder 322 may be implemented as close to logic that may be used to process the sensor data, such as, in this case, as a part of the controller application 312.

In some cases, by using encryption, an amount of unencrypted EM emissions can be greatly reduced. That is, EM emissions may be generated as the encrypted sensor data is transmitted from the encoder 320 to the sensor transmitter 306, across the transmission medium to the controller receiver 310, and on to the decoder 322, but these encrypted EM emissions may be secure due to the encryption. However, while reduced, unencrypted transmission EM emissions 324 can still occur between the sensor 302 and the sensor logic board 304 as the sensor may still transmit the sensor data to the encoder 320. Additionally, unencrypted transmission EM emissions 324 may still occur even where the sensor logic board 304 is integrated with the sensor 302. Additionally, unencrypted in-chip EM emissions 316 may be present in the sensor logic board 304 and/or controller application 312. In some cases, techniques to reduce these unencrypted EM emissions may be useful.

A modified form of data scrambling may be used to further reduce unencrypted EM emissions. In some cases, nominal data scrambling based on a fixed operator published as a part of a protocol standard may be subject to reverse-engineering. Rather than using a fixed operator, a dynamic operator may be used to provide secure scrambling.

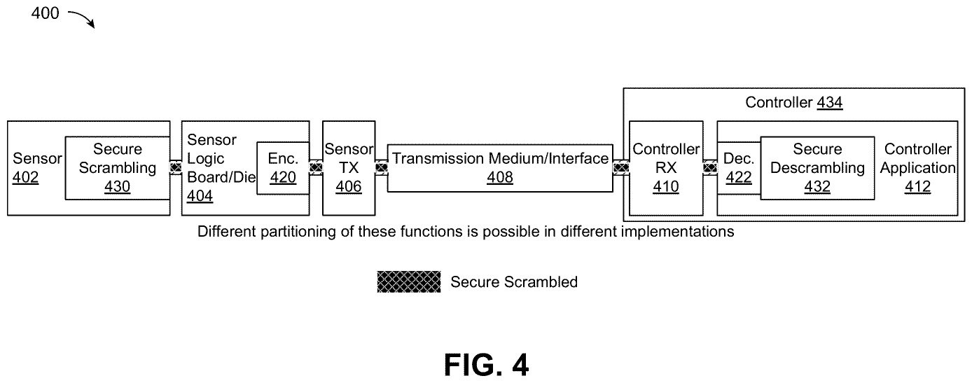

FIG. 4 is a block diagram illustrating secure scrambling for an imaging system 400, in accordance with aspects of the present disclosure. Similar to imaging system 300, the imaging system 400 includes a sensor 402, sensor logic board 404 including an encoder 420, a sensor transmitter 406, transmission medium 408, controller receiver 410 including a decoder 422, and controller application 412. As in FIG. 4, the sensor 402 may include a secure scrambling engine 430, and the controller application 412 may include a secure descrambling engine 432. In some cases, the controller application 412 and the controller receiver 410 may be part of a sensor controller 434, such as an ISP, DSP, CPU, SoC, etc. Of note, while shown integrated on the sensor 402, the secure scrambling engine 430 may also be integrated with the sensor logic board 404. Similarly, while secure descrambling engine 432 is shown integrated with the controller application, the secure descrambling engine 432 (and decoder 422) may be integrated with the controller receiver 410.

In some cases, the secure scrambling engine 430 may be scramble sensor data based on a cryptographic key shared between a sensor system (e.g., sensor module), such as an imaging sensor system, and the sensor controller 434. For example, the sensor system may be registered with the sensor controller 434 (e.g., a SoC, ISP, etc.) during manufacturing process, such as during a registration procedure. In some cases, the sensor system may include the sensor 402 and the sensor logic board 404. For example, the sensor 402 and sensor logic board 404 may be etched (e.g., printed) on separate semiconductor dies and these semiconductor dies may be joined, for example, via a die-to-die interface (e.g., connection). In some cases, the semiconductor dies may be placed together in a single package (e.g., the imaging sensor system). In other cases, the separate semiconductor dies may be separately packaged and placed on one or more printed circuit boards (PCBs) which are connected, for example, via traces, wires, paths, etc. as the imaging sensor system.

As a part of the registration procedure, the sensor system and the sensor controller 434 may exchange a secret root key from which other keys (e.g., derived keys) may be derived from using a key derivation function. In some cases, a security handshake operation between the sensor system and the sensor controller 434 may be, for example, periodically performed based on a derived key (e.g., session key, keystream, etc.). As more specific examples, the sensor system and the sensor controller 434 may perform a security handshake operation during a system boot or restart procedure for the sensor and/or device, after a certain amount of time has passed, after a certain amount of time operating has passed, etc. A new derived key may be generated during each security handshake operation. In some cases, the derived key from the security handshake operation may also be used for scrambling sensor data as between the sensor 402 and sensor controller 434 as a part of secure scrambling. In some cases, the sensor logic board 404 of a sensor system may perform the security handshake operation with the sensor controller 434 and generate a session key. For example, the sensor 402 may have relatively simple logic and adding logic to perform cryptographic operations, such as a key derivation function may be relatively costly (e.g., in terms of chip area, added complexity, etc.). As the sensor logic board 404 may more cost effectively support more complex logic as compared to the sensor 402, the sensor logic board 404 may include logic for performing the security handshake operation and key derivation operation.

After the derived key is generated by the sensor logic board 404, a sync value based on the derived key may be passed to the sensor 402. The sensor 402 may scramble the sensor data as the sensor data is generated. For example, the secure scrambling engine 430 may be located after digital signals (e.g., sensor data) are generated (e.g., by sensing the photodiodes of the sensor 402 to generate digital values) and before the generated sensor data is stored or processed by another circuit. In some cases, the sensor data may be a part of data stream generated by the sensor 402. The scrambled sensor data may be passed to sensor logic board 404. In some cases, the scrambled sensor data may be encrypted by an encoder 420 in a manner substantially similar to that discussed above with respect to encoder 320 of FIG. 3. The encrypted sensor data may be transmitted to the sensor controller 434 and decoded by decoder 422 in a manner substantially similar to that discussed above with respect to FIG. 3.

After decoding, the scrambled sensor data may be descrambled by the secure descrambling engine 432. The secure descrambling engine 432 may be located just prior to the controller application 412 (e.g., circuitry to process the image data). Multiple secure descrambling engines 432 may be present in the sensor controller 434. In some cases, the sensor controller 434 may pass the derived key to portions of the sensor controller 434, such as the controller application 412, as needed to descramble the scrambled sensor data. In some cases, the secure descrambling engine 432 may be substantially similar to the secure scrambling engine 430.

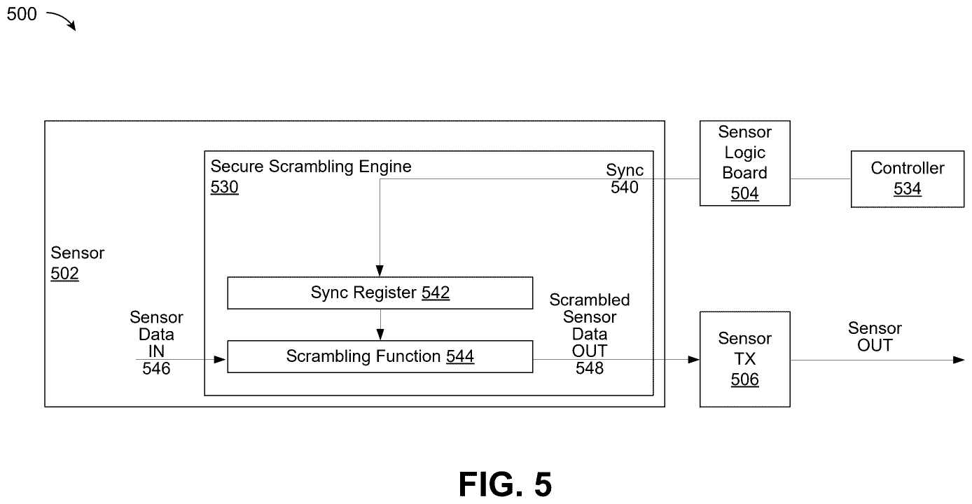

FIG. 5 is a block diagram illustrating secure scrambling for sensor data 500, in accordance with aspects of the present disclosure. FIG. 5 includes a sensor 502, a sensor logic board 504, a sensor transmitter 506, and a controller 534. The sensor 502 may be substantially similar to sensor 402 of FIG. 4. The sensor logic board 504 may be substantially similar to sensor logic board 404 of FIG. 4. The sensor transmitter 506 may be substantially similar to sensor transmitter 406 of FIG. 4. The controller 534 may be substantially similar to sensor controller 434 of FIG. 4. The controller 534 and the sensor logic board 504 may derive a session key (e.g., derived key, keystream) as a part of a security handshake operation. In some cases, the sensor logic board 504 may generate a set of sync bits 540 based on the session key.

In some cases, the scrambling may be applied as close to the generation of the sensor data as practicable. For example, the scrambling may be applied on the sensor 502 just after the digital measurement of the environment is performed. In some cases, the sync bits 540 may be directly extracted from the session key. For example, an n number of bits of the session key may be used as the sync bits 540. These n bits may be from a predetermined portion of the session key, such as the least significant n bits, most significant n bits, etc. In other cases, the sync bits 540 may be derived from the session key based on a cryptographic function, such as a key derivation function. In some cases, the key derivation function may be a fixed key derivation function which accepts the session key without requiring another input value and derives the sync bits 540. After the sync bits 540 are generated, the sync bits 540 may be loaded into a sync register 542 of the secure scrambling engine 530. In some cases, the sync register 542 may be a set of n registers that the sync bits may be stored in.

The secure scrambling engine 530 may also include a scrambling function 544 and sensor data may be input 546 to the scrambling function 544. The scrambling function 544 may scramble the sensor data based on the sync bits 540 in the sync register 542. In some cases, the scrambling function may be performed with relatively simple logic, as compared to data encryption. For example, the scrambling function 544 may be an exclusive-or (XOR) operation, or other similar logic operator, between the sensor data and the sync bits 540. In some cases, the sensor data may be loaded into the scrambling function 544 for scrambling as the sensor data is being read (e.g., just after the analog signal is converted to a digital signal). The scrambled sensor data may be output 548 to the sensor transmitter 506 for output. In some cases, a secure descrambling engine, such as secure descrambling engine 432 of FIG. 4, may be substantially similar to secure scrambling engine 530.

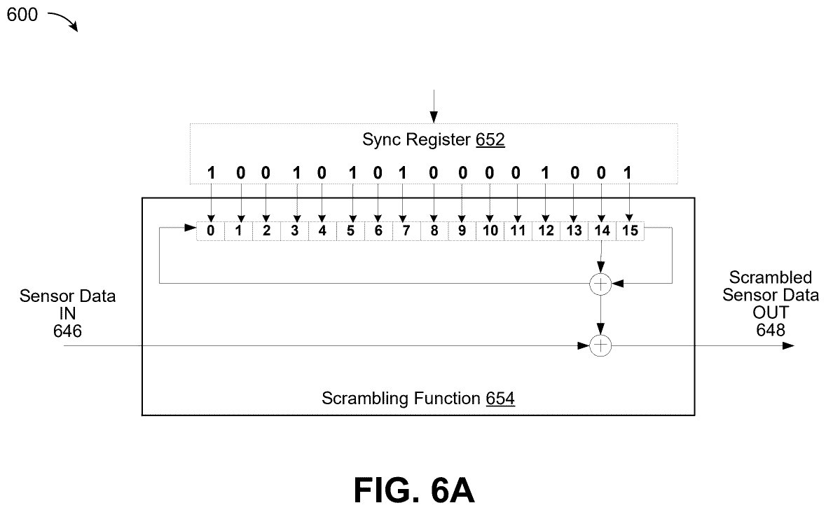

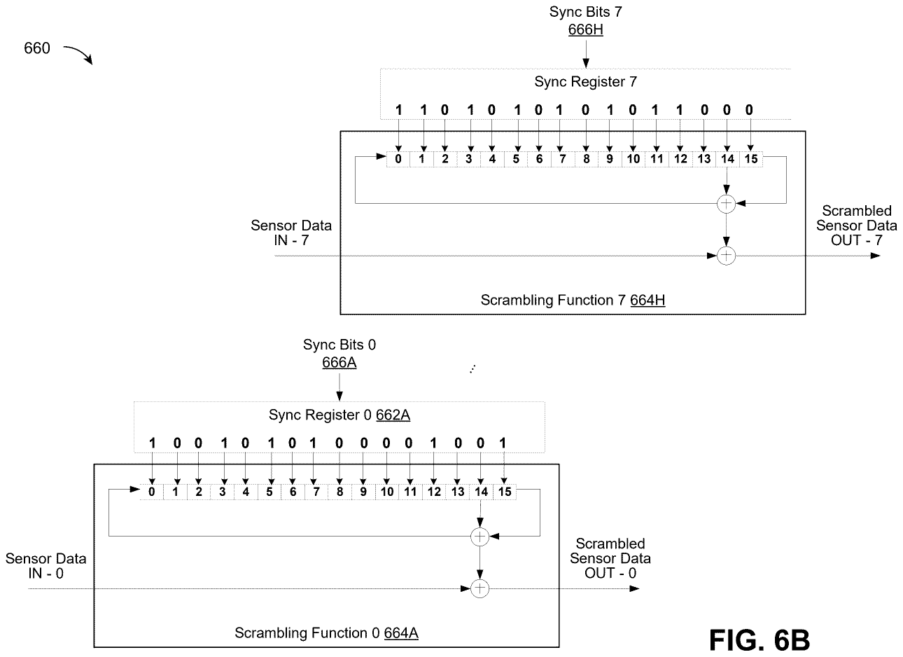

FIG. 6A illustrates an example secure scrambling engine 600, in accordance with aspects of the present disclosure. The secure scrambling engine 600 includes a sync register 652 and a scrambling function 654. Values of sync bits may be loaded into the sync register 652. The scrambling function 654 may be an XOR function that XORs input bits of the input sensor data 646 with the values of the sync bits. For example, the scrambling function may be implemented as a clocked linear feedback shift register (LFSR) which advances through the values of the sync bits in the sync register (e.g., from register 0 to 15) and performs an XOR operation with a bit of the input sensor data 646 and a particular bit of the sync bits to generate output scrambled sensor data 648. Of note, while a 16-bit sync register 652 is shown, the sync register 652 may be any size.

FIG. 6B is a block diagram illustrating a set of parallel secure scrambling engines 660, in accordance with aspects of the present disclosure. In some cases, multiple scrambling functions 664A, . . . 664H, such as LFSRs, may be arranged in parallel, such as 8 LFSRs, to process, for example, a byte of the input sensor data 646 at a time. In some cases, multiple sets of sync bits may be used for the multiple LFSRs of the scrambling function 644. For example, a first set of sync bits 666A may be passed to a first sync register 662A, a second set of sync bits 666B may be passed to a second sync register 662B, and so forth. Each set of sync bits 666A, . . . , 666H may be derived independently from the session key.

In some cases, a secure descrambling engine may be substantially similar to the secure scrambling engine 600 or the set of parallel secure scrambling engines 650. For example, an XORed value may be reversed (e.g., descrambled) by XORing the XORed value with the original value (e.g., sync bit values) used to generate the XORed value. Thus, a controller, such as sensor controller 434 of FIG. 4, may generate sync bits based on the session key in a manner substantially similar to that described above with respect to the FIGS. 4 and 5. The sync bits may be used by a descrambling function of the secure descrambling engine in a manner substantially similar to that described above for the scrambling function 654.

In some cases, a controller may not implement end-to-end security with respect to a controller receiver. For example, the controller receiver may receive a scrambled signal scrambled by an encoder on a sensor logic board/die and the controller receiver may descramble the signal and transmit the descrambled signal to the controller and controller application. Such a setup may be referred to as a “last centimeter” issue between the controller receiver and the controller. As a more specific example, legacy controllers may not support receiving scrambled signals. As another example, ethernet in-vehicle networks (IVN) may use media access control security (MACsec) as between the encoder and decoder, but the interface between the controller receiver and the controller itself may be left unsecured. In some cases, it may be useful to maintain some level of security (e.g., implied security via secured scrambling) for such “last centimeter” connections between the controller receiver and the controller.

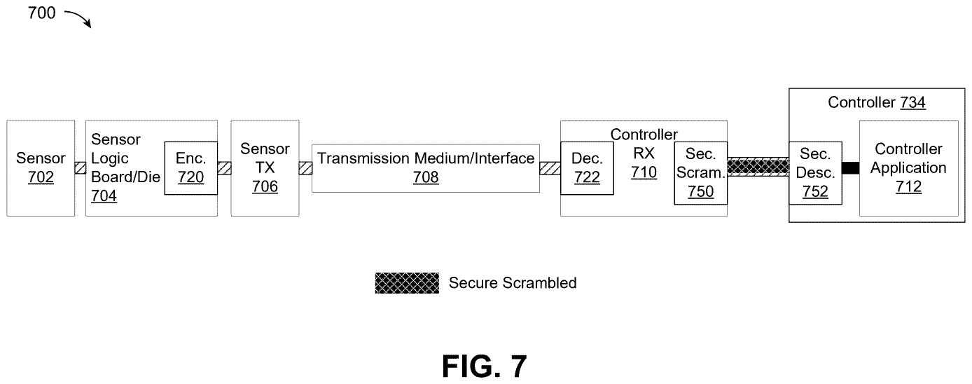

FIG. 7 is a block diagram illustrating secure scrambling for an imaging system 700, in accordance with aspects of the present disclosure. Similar to imaging system 300 and imaging system 400, the imaging system 700 includes a sensor 702, sensor logic board 704 including an encoder 720, a sensor transmitter 706, transmission medium 708, a controller receiver 710, and a controller 734. In some cases, the controller receiver 710 may be separate from, or integrated with the controller 734. The controller receiver 710 may include a decoder 722. In some cases, the encoder 720 and decoder 722 may be a serializer transmitter and deserializer receiver, respectively. Transmissions between the encoder 720 and decoder 722 may be cryptographically secured (e.g., via a security handshake (e.g. TLS, SPDM), followed by integrity/encryption on data/control interfaces).

In some cases, the decoder 722 of the controller receiver 710 may decrypt the transmission from the encoder 720. The transmission may then be passed to a secure scrambling engine 750 of the controller receiver 710. The secure scrambling engine 750 may be substantially similar to the secure scrambling engine 430 of FIG. 4. In some cases, the scrambling may be performed in the protocol layer or PHY layer, whose layers implement a cyclic redundancy check (CRC) over the scrambled data, providing some integrity protection. The scrambling may be performed based on a security keys (e.g. session keys, traffic keys) that may be shared between the controller receiver 710 and the controller 734 based on a security handshake, as described above. In some cases, the controller receiver 710 may be registered with the controller 734 during manufacturing process, such as during a registration procedure. Scrambling may be performed in a manner substantially similar to that described with respect to FIGS. 5 and 6A-6B.

The scrambled transmission may be output by the secure scrambling engine 750 to a secure descrambling engine 752 of the controller. In some cases, the secure descrambling engine 752 may be substantially similar to the secure descrambling engine 432 of FIG. 4.

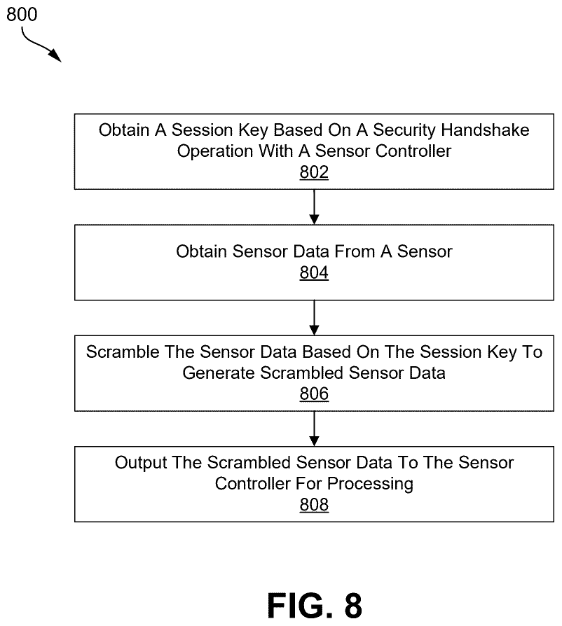

FIG. 8 is a flow diagram illustrating a process 800 for securing data, in accordance with aspects of the present disclosure. The process 800 may be performed by a computing device (or apparatus) or a component (e.g., a chipset, codec, etc.) of the computing device, such as image capturing and processing system 100 of FIG. 1. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 00 may be implemented as software components that are executed and run on one or more processors (e.g., the image processor 150 of FIG. 1, the host processor 152 of FIG. 1, sensor 402 of FIG. 4, sensor logic board 404 of FIG. 4, sensor controller 434 of FIG. 4, controller application 412 of FIG. 4, sensor 502 of FIG. 5, processor 810 of FIG. 8, and/or other processor(s)). In some cases, the operations of the process 800 can be implemented by a system having the architecture of computing system 900 of FIG. 9.

At block 802, the computing device (or component thereof) may obtain a session key based on a security handshake operation with a sensor controller. In some cases, the session key may be a symmetric temporary session key that may be used to establish a secure connection. In some cases, as a part of the registration procedure as a part of manufacturing, a sensor system (e.g., sensor logic and sensor) and a sensor controller (e.g., ISP, SoC, etc.) may exchange a secret root key that may be used to derive other cryptographic keys, such as the session key using a key derivation function. In some examples, the security handshake operation is performed during boot of the computing device (or component thereof).

At block 804, the computing device (or component thereof) may obtain sensor data from a sensor (e.g., image sensor 130, sensor 202 of FIG. 2, sensor 302 of FIG. 3, sensor 402 of FIG. 4, sensor 502 of FIG. 5, etc.). In some cases, the sensor comprises a camera, and wherein the sensor data comprises image data.

At block 806, the computing device (or component thereof) may scramble (e.g., via secure scrambling engine 430 of FIG. 4, secure scrambling engine 530 of FIG. 5, scrambling function 654 of FIG. 6A, scrambling functions 664A, . . . 664H of FIG. 6B, etc.) the sensor data based on the session key to generate scrambled sensor data. In some cases, the computing device (or component thereof) may scramble the sensor data based on the session key by generating sync bits based on the session key, and wherein the sensor data is scrambled based on the sync bits. In some examples, the sync bits are generated based on a predetermined portion of the session key. In some cases, the sync bits are generated based on the session key. For example, the sync bits may be derived from the session key based on a cryptographic function, such as a key derivation function. In some examples, the sensor data is scrambled using an exclusive or (XOR) operation (or other similar logic operator) with the sync bits. In some cases, the scrambled sensor data is decoded by the sensor controller based on the XOR operation using the sync bits. In some examples, the computing device (or component thereof) may encrypt (e.g., via encoder 420 of FIG. 4) the scrambled sensor data.

At block 808, the computing device (or component thereof) may output the scrambled sensor data to the sensor controller (e.g., controller 434 of FIG. 4, controller 534 of FIG. 5, etc.) for processing.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 800 and/or other processes described herein may include a processor, microprocessor, micro-computer, or other component of a device that is configured to carry out the steps of the process 800 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, camera, accelerometers, gyroscopes, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.10 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some examples, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the present disclosure include:

Aspect 1. An apparatus for securing data, the apparatus comprising: at least one memory; and at least one processor coupled to the at least one memory, the at least one processor being configured to: obtain a session key based on a security handshake operation with a sensor controller; obtain sensor data from a sensor; scramble the sensor data based on the session key to generate scrambled sensor data; and output the scrambled sensor data to the sensor controller for processing.

Aspect 2. The apparatus of Aspect 1, wherein, to scramble the sensor data based on the session key, the at least one processor is further configured to: generate sync bits based on the session key, and wherein the sensor data is scrambled based on the sync bits.

Aspect 3. The apparatus of Aspect 2, wherein the sync bits are generated based on a predetermined portion of the session key.

Aspect 4. The apparatus of Aspect 2, wherein the sync bits are generated based on the session key.

Aspect 5. The apparatus of any of Aspects 2-4, wherein the sensor data is scrambled using an exclusive or (XOR) operation with the sync bits.

Aspect 6. The apparatus of Aspect 5, wherein the scrambled sensor data is decoded by the sensor controller based on the XOR operation using the sync bits.

Aspect 7. The apparatus of any of Aspects 1-6, wherein the security handshake operation is performed during boot of the apparatus.

Aspect 8. The apparatus of any of Aspects 1-7, wherein the at least one processor is further configured to encrypt the scrambled sensor data.

Aspect 9. The apparatus of any of Aspects 1-8, wherein the sensor comprises a camera, and wherein the sensor data comprises image data.

Aspect 10. The apparatus of any of Aspects 1-9, wherein the sensor data from the sensor is encrypted, and wherein the at least one processor is further configured to decrypt the sensor data.

Aspect 11. A method for securing data, comprising: obtaining a session key based on a security handshake operation with a sensor controller; obtaining sensor data from a sensor; scrambling the sensor data based on the session key to generate scrambled sensor data; and outputting the scrambled sensor data to the sensor controller for processing.

Aspect 12. The method of Aspect 11, wherein scrambling the sensor data based on the session key comprises generating sync bits based on the session key, and wherein the sensor data is scrambled based on the sync bits.

Aspect 13. The method of Aspect 12, wherein the sync bits are generated based on a predetermined portion of the session key.

Aspect 14. The method of Aspect 12, wherein the sync bits are generated based on the session key.

Aspect 15. The method of any of Aspects 11-14, wherein the sensor data is scrambled using an exclusive or (XOR) operation with the sync bits.

Aspect 16. The method of Aspect 15, wherein the scrambled sensor data is decoded by the sensor controller based on the XOR operation using the sync bits.

Aspect 17. The method of any of Aspects 11-16, wherein the security handshake operation is performed during boot of a device.

Aspect 18. The method of any of Aspects 11-17, further comprising encrypting the scrambled sensor data.

Aspect 19. The method of any of Aspects 11-18, wherein the sensor comprises a camera, and wherein the sensor data comprises image data.

Aspect 20. The method of Aspect 11, wherein the sensor data from the sensor is encrypted, and further comprising decrypting the sensor data.

Aspect 21. A non-transitory computer-readable medium having stored thereon instructions that, when executed by at least one processor, cause the at least one processor to: obtain a session key based on a security handshake operation with a sensor controller; obtain sensor data from a sensor; scramble the sensor data based on the session key to generate scrambled sensor data; and output the scrambled sensor data to the sensor controller for processing.

Aspect 22. The non-transitory computer-readable medium of Aspect 21, wherein, to scramble the sensor data based on the session key, the instructions cause the at least one processor to: generate sync bits based on the session key, and wherein the sensor data is scrambled based on the sync bits.

Aspect 23. A non-transitory computer-readable medium having stored thereon instructions that, when executed by at least one processor, cause the at least one processor to perform operations according to any of Aspects 11-20.

Aspect 24: An apparatus for securing data, comprising one or more means for performing one or more of operations according to any of Aspects 11-20.

What is claimed is:

1. An apparatus for securing data, the apparatus comprising:
at least one memory; and
at least one processor coupled to the at least one memory, the at least one processor being configured to:
obtain a session key based on a security handshake operation with a sensor controller;
obtain sensor data from a sensor;
scramble the sensor data based on the session key to generate scrambled sensor data; and
output the scrambled sensor data to the sensor controller for processing.

2. The apparatus of claim 1, wherein, to scramble the sensor data based on the session key, the at least one processor is further configured to:
generate sync bits based on the session key, and wherein the sensor data is scrambled based on the sync bits.

3. The apparatus of claim 2, wherein the sync bits are generated based on a predetermined portion of the session key.

4. The apparatus of claim 2, wherein the sync bits are generated based on the session key.

5. The apparatus of claim 2, wherein the sensor data is scrambled using an exclusive or (XOR) operation with the sync bits.

6. The apparatus of claim 5, wherein the scrambled sensor data is decoded by the sensor controller based on the XOR operation using the sync bits.

7. The apparatus of claim 1, wherein the security handshake operation is performed during boot of the apparatus.

8. The apparatus of claim 1, wherein the at least one processor is further configured to encrypt the scrambled sensor data.

9. The apparatus of claim 1, wherein the sensor comprises a camera, and wherein the sensor data comprises image data.

10. The apparatus of claim 1, wherein the sensor data from the sensor is encrypted, and wherein the at least one processor is further configured to decrypt the sensor data.

11. A method for securing data, comprising:
obtaining a session key based on a security handshake operation with a sensor controller;
obtaining sensor data from a sensor;
scrambling the sensor data based on the session key to generate scrambled sensor data; and
outputting the scrambled sensor data to the sensor controller for processing.

12. The method of claim 11, wherein scrambling the sensor data based on the session key comprises generating sync bits based on the session key, and wherein the sensor data is scrambled based on the sync bits.

13. The method of claim 12, wherein the sync bits are generated based on a predetermined portion of the session key.

14. The method of claim 12, wherein the sync bits are generated based on the session key.

15. The method of claim 12, wherein the sensor data is scrambled using an exclusive or (XOR) operation with the sync bits.

16. The method of claim 15, wherein the scrambled sensor data is decoded by the sensor controller based on the XOR operation using the sync bits.

17. The method of claim 11, wherein the security handshake operation is performed during boot of a device.

18. The method of claim 11, further comprising encrypting the scrambled sensor data.

19. The method of claim 11, wherein the sensor comprises a camera, and wherein the sensor data comprises image data.

20. The method of claim 11, wherein the sensor data from the sensor is encrypted, further comprising decrypting the sensor data.
